(19) United States
(12) Patent Application Publication
(10) Pub. No.: US 2013/0169232 A1
(43) Pub. Date: Jul. 4, 2013

(54) METHODS AND SYSTEMS FOR MONITORING AND USING AN ELECTRICAL ENERGY-STORAGE DEVICE

(71) Applicants: Justin Dale MIDDLETON, Peoria, IL (US); David Longsford Collins, Peoria, IL (US); John Joseph Votoupal, Hudson, IL (US); Wellington Ying-Wei Kwok, Dunlap, IL (US)

(72) Inventors: Justin Dale MIDDLETON, Peoria, IL (US); David Longsford Collins, Peoria, IL (US); John Joseph Votoupal, Hudson, IL (US); Wellington Ying-Wei Kwok, Dunlap, IL (US)

(73) Assignee: Caterpillar Inc.

(21) Appl. No.: 13/341,318

(22) Filed: Dec. 30, 2011

(51) Int. Cl. H02J 7/00; G01N 27/416

(52) U.S. Cl. 320/134; 324/426

(57) ABSTRACT

One disclosed embodiment relates to a method of estimating a state of health of an electrical energy-storage device. The method may include receiving information indicative of a history of a voltage level of the electrical energy-storage device during a history of charging and discharging of the electrical energy-storage device. The method may also include using the received information to estimate at least one peak or valley in the history of the voltage level. Additionally, the method may include using at least one information-processing device to generate an estimate of a state of health of the electrical energy-storage device based on the at least one estimated peak or valley.

### TECHNICAL FIELD

The present disclosure relates to electrical energy-storage devices and, more particularly, to methods and systems for monitoring and using electrical energy-storage devices.

### BACKGROUND

Many systems use an electrical energy-storage device (e.g., a battery or capacitor) to supply electricity to one or more electrical loads. Operating such systems often involves monitoring one or more parameters of the operating state of the electrical energy-storage device and controlling one or more aspects of the system based on the monitored parameters.

For example, U.S. Pat. No. 6,232,744 to Kawai et al. (“the '744 patent”) discloses a hybrid power system with a battery, as well as a method that involves monitoring a voltage level of the battery and controlling charging and discharging of the battery based on the voltage level. The '744 patent discloses determining whether the battery requires charging or discharging by comparing a calculated voltage of the battery to a target voltage. If the calculated battery voltage falls below the target voltage, the method of the '744 patent deems the battery in need of charging. On the other hand, if the calculated battery voltage exceeds the target voltage, the method deems the battery in need of discharging.

Although the '744 patent discloses a method of charging and discharging an electrical energy-storage device, certain disadvantages may persist. With time and use, the characteristics of the electrical energy-storage device and its response to charging and discharging may change in ways that reduce its ability to effectively receive, store, and discharge electricity. As a result, an approach that may work well for charging and discharging the electrical energy-storage device at the beginning of its life may work less well later in its life. The '744 patent does not discuss degradation of the electrical energy-storage device that occurs over time, or any way to monitor or adjust for such degradation.

The methods and systems of the present disclosure may solve one or more of the problems set forth above.

### SUMMARY

One disclosed embodiment relates to a method of estimating a state of health of an electrical energy-storage device. The method may include receiving information indicative of a history of a voltage level of the electrical energy-storage device during a history of charging and discharging of the electrical energy-storage device. The method may also include using the received information to estimate at least one peak or valley in the history of the voltage level. Additionally, the method may include using at least one information-processing device to generate an estimate of a state of health of the electrical energy-storage device based on the at least one estimated peak or valley.

Another embodiment relates to a method of operating a power system with an electrical energy-storage device. The method may include charging and discharging the electrical energy-storage device according to a charging and discharging strategy. The method may also include receiving information indicative of a history of a voltage level of the electrical energy-storage device during a history of the charging and discharging of the electrical energy-storage device. Additionally, the method may include modifying the charging and discharging strategy in response to a change in a pattern of fluctuation of the voltage level during the history of charging and discharging.

A further disclosed embodiment relates to a power system. The power system may include an electrical energy-storage device and at least one information-processing device. The at least one information-processing device may be configured to receive information indicative of a history of a voltage level of the electrical energy-storage device during a history of charging and discharging of the electrical energy-storage device. The at least one information-processing device may also be configured to identify peaks and valleys in the history of the voltage level of the electrical energy-storage device. The at least one information-processing device may further be configured to perform at least one of monitoring a state of charge of the electrical energy-storage device based at least in part on the identified peaks and valleys or controlling the state of charge of the electrical energy-storage device based at least in part on the identified peaks and valleys.

### BRIEF DESCRIPTION OF THE DRAWINGS

FIG. 1 shows one embodiment of a machine having a power system according to the present disclosure;

FIG. 2 shows one embodiment of a power system according to the present disclosure in more detail;

FIG. 3A graphically illustrates one example of how the voltage level of an electrical energy-storage device may vary over time;

FIG. 3B graphically illustrates another example of how the voltage level of an electrical energy-storage device may vary over time; and

FIG. 3C graphically illustrates another example of how the voltage level of an electrical energy-storage device may vary over time.

### DETAILED DESCRIPTION

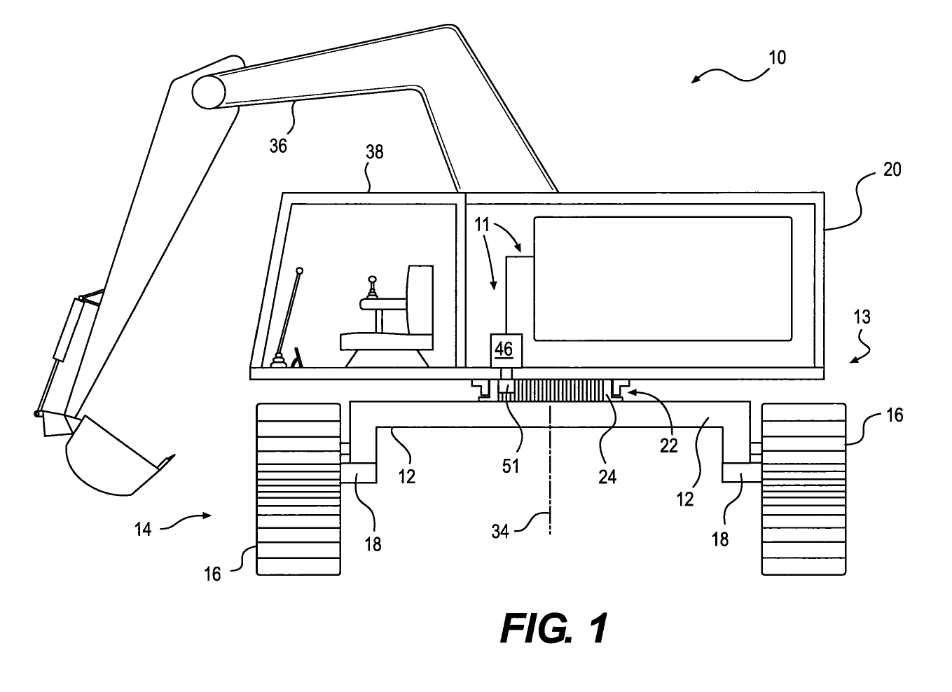

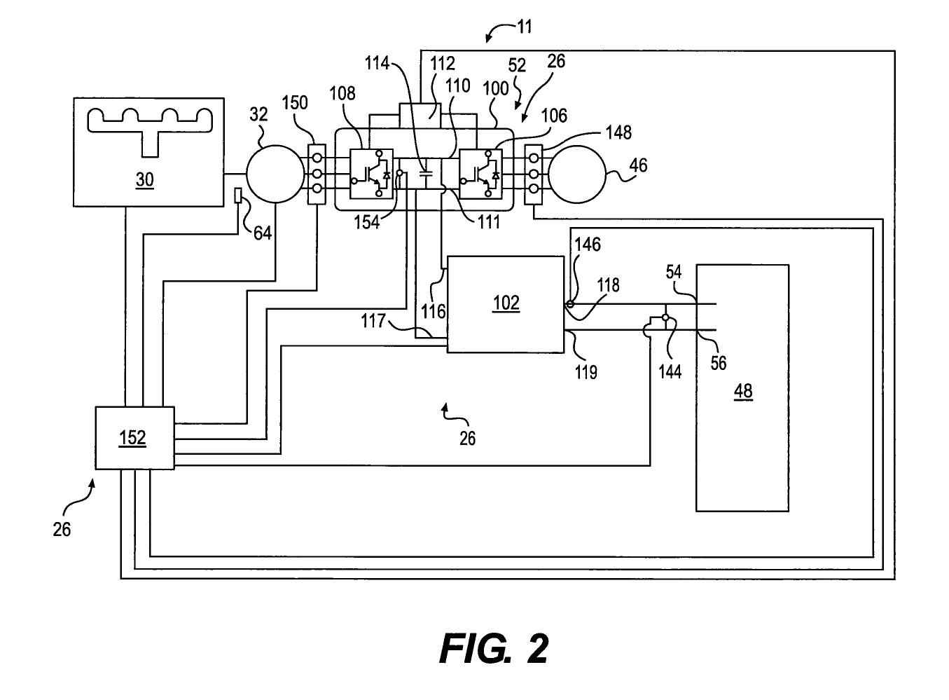

FIGS. 1 and 2 show a machine 10, a power system 11, and various components thereof according to the present disclosure. Machine 10 may be any type of machine that employs power to perform one or more tasks. For example, machine 10 may be a mobile machine configured to transport or move people, goods, or other matter or objects. Additionally, or alternatively, machine 10 may be configured to perform a variety of other operations associated with a commercial or industrial pursuit, such as mining, construction, energy exploration and/or generation, manufacturing, transportation, and agriculture.

As shown in FIG. 1, in some embodiments, machine 10 may be an excavator configured for digging. Machine 10 may include a chassis 13 to which other components of machine 10 are attached. In the example shown in FIG. 1, chassis 13 may include an undercarriage 14 and a superstructure 20. Undercarriage 14 may include a frame 12. In some embodiments, machine 10 may be a mobile machine, and undercarriage 14 may include one or more propulsion devices 16 for propelling machine 10. Propulsion devices 16 may be any type of device configured to propel machine 10. For example, as FIG. 1 shows, propulsion devices 16 may be track units. Alternatively, propulsion devices 16 may be wheels or other types of devices operable to propel machine 10. Undercarriage 14 may also include one or more components for driving propulsion devices 16. For example, undercarriage 14 may include drive motors 18 for driving propulsion devices 16. Drive motors 18 may be electric motors or hydraulic motors.

Superstructure 20 may be suspended from frame 12. In some embodiments superstructure 20 may be suspended from frame 12 by a pivot system 22. Pivot system 22 may include a swing bearing 24 and an electric motor 46. Swing bearing 24 may include an inner race mounted to frame 12 and an outer race to which superstructure 20 mounts. Both the inner and outer race of swing bearing 24 may extend concentric to a vertical axis 34. Electric motor 46 may be operable to rotate superstructure 20 and the outer race of swing bearing 24 around axis 34. Electric motor 46 may have a gear 51 mounted to its output shaft, and electric motor 46 may mount to superstructure 20 in a position such that gear 51 meshes with gear teeth on frame 12. Electric motor 46 may receive power to rotate superstructure 20 around axis 34 from various components of power system 11. Electric motor 46 may constitute one of many electrical power loads of power system 11.

Machine 10 may include various other components. For example, as FIG. 1 shows, machine 10 may include an implement 36. Implement 36 may be mounted to various parts of machine 10 and configured to perform various tasks. In some embodiments, implement 36 may be mounted to superstructure 20 and configured to perform digging. Machine 10 may also include an operator station 38 from which an individual can control one or more aspects of the operation of machine 10. Operator station 38 may also be mounted to superstructure 20.

FIG. 2 shows power system 11 in greater detail. Power system 11 may include power-system controls 26 and various components operable to provide power to perform various tasks. In some embodiments, power system 11 may be a hybrid-electric power system. In addition to power-system controls 26, power system 11 may include electric motor 46, a prime mover 30, an electric motor/generator 32, an electrical energy-storage device 48, and a power-transmission system 52. As used herein, the term “electric motor/generator” refers to any electrical device configured to operate as an electric motor when receiving electrical power and/or to operate as an electric generator when being mechanically driven.

Prime mover 30 may be any type of device configured to produce mechanical power to drive electric motor/generator 32. For example, prime mover 30 may be a diesel engine, a gasoline engine, a gaseous fuel-powered engine, or any other type of component operable to produce mechanical power.

Electric motor/generator 32 may be any type of component operable to generate electricity with mechanical power received from prime mover 30. Electric motor/generator 32 may also be operable to receive electricity and operate as an electric motor to drive prime mover 30 for a number of purposes. Electric motor 46 may be any type of component operable to receive electricity from power-transmission system 52 and generate mechanical power with that electricity. Each of electric motor/generator 32 and electric motor 46 may be, for example, any of a permanent-magnet electric machine, a switched-reluctance electric machine, a DC electric machine, an induction-type machine or any other type of electric machine known in the art.

Electrical energy-storage device 48 may be any type of device operable to store electrical energy and exchange electricity with (i.e., receive electricity from and deliver electricity to) power-transmission system 52. For example, electrical energy-storage device 48 may include one or more batteries and/or one or more capacitors. Electrical energy-storage device 48 may include a positive terminal 54 and a negative terminal 56.

Power-transmission system 52 may include an inverter 100, a power regulator 102, and various electrical connectors, such as electric lines and/or electric switches connecting these devices. Inverter may 100 include a power electronics unit 106, a power electronics unit 108, power lines 110, 111, a bulk capacitor 114, and a controller 112. Power electronics unit 106 may be operable to regulate a flow of power between electric motor 46 and power lines 110, 111. Power electronics module 108 may similarly be operable to regulate a flow of power between electric motor/generator 32 and power lines 110, 111. Bulk capacitor 114 may be connected between power lines 110, 111 and serve to smooth out any fluctuations in voltage across power lines 110, 111. This configuration of inverter 100 may allow exchange of electricity between electric motor/generator 32 and electric motor 46 via power electronics modules 106, 108 and power lines 110, 111.

Controller 112 may be operatively connected to power electronics modules 106, 108, and controller 112 may be configured (e.g., programmed) to control one or more aspects of the operation of power electronics modules 106, 108. In some embodiments, controller 112 may include, for example, one or more microprocessors and/or one or more memory devices.

Power regulator 102 may include input/output terminals 116, 117, 118, 119. Power regulator 102 may have any configuration that allows it to regulate one or more aspects of electricity exchanged between terminals 116, 117 and terminals 118, 119. Power regulator 102 may, for example, be operable to control whether electricity is exchanged between terminals 116, 117 and terminals 118, 119. Power regulator 102 may also be configured to control which direction electricity flows between terminals 116, 117 and terminals 118, 119, i.e., whether electricity flows from terminals 116, 117 to terminals 118, 119, or vice-a-versa. Power regulator 102 may exchange electricity in various forms. In some embodiments, power regulator 102 may be configured to receive and/or supply direct current electricity at terminals 116, 117, 118, 119. Power regulator 102 may also be operable to control the voltage at each of terminals 116, 117, 118, 119 as well as the magnitude of electric current flowing at each of terminals 116, 117, 118, 119. For example, power regulator 102 may be operable to change the electricity transmitted between terminals 116, 117 and terminals 118, 119 from one voltage of direct current electricity at terminals 116, 117 to another voltage of direct current electricity at terminals 118, 119. As discussed further below, power regulator 102 may be controllable by one or more other component(s) of power system 11, so that those other components may control how power regulator 102 controls the exchange of electricity between terminals 116, 117 and terminals 118, 119. Power regulator 102 may include any suitable configuration of components that allows it to provide the above-discussed functionality.

Inverter 100, power regulator 102, electrical energy-storage device 48, electric motor 46, and electric motor/generator 32 may be electrically connected to one another in various ways. As FIG. 2 shows, in some embodiments, terminals 116, 117 of power regulator 102 may be electrically connected to power lines 110, 111 of inverter 100. This may allow exchange of electricity between power regulator 102, electric motor 46, and electric motor/generator 32 via power lines 110, 111 of inverter 100. Additionally, power-transmission system 52 may have provisions connecting terminals 118, 119 of power regulator 102 directly or indirectly to electrical energy-storage device 48. For example, terminals 118, 119 of power regulator 102 may, for example, be continuously electrically connected to terminals 54 and 56 of electrical energy-storage device 48.

The exemplary configuration of power-transmission system 52 shown in FIG. 2 may allow it to transmit electricity between electric motor/generator 32, electric motor 46, and electrical energy-storage device 48 in various ways through inverter 100 and power regulator 102. For example, power-transmission system 52 may transmit electricity from electric motor/generator 32, through inverter 100, to electric motor 46, thereby operating electric motor 46 to rotate superstructure 20. Additionally or alternatively, power-transmission system 52 may at times discharge electricity from electrical energy-storage device 48, through power regulator 102, to inverter 100, to electric motor 46 to rotate superstructure 20. At other times, power-transmission system 52 may charge electrical energy-storage device 48 by transmitting electricity from inverter 100 (e.g. electricity generated by electric motor/generator 32) through power regulator 102, to electrical energy-storage device 48.

In addition to those shown in FIG. 2, power system 11 may also include a number of other electrical loads and/or sources. For example, in addition to electric motor 46, power system 11 may include various other large, high-voltage electrical loads, such as drive motors 18, connected to power lines 110, 111 of inverter 100. Additionally, power system 11 may have various smaller, low-voltage loads, such as lights, gauges, sensors, fan motors, and the like.

Power-system controls 26 may be configured to control charging and discharging of electrical energy-storage device 48, operation of prime mover 30, operation of electric motor/generator 32, operation of electric motor 46, and transmission of electricity through power-transmission system 52 in connection with all of these tasks. Power-system controls 26 may include inverter 100 and power regulator 102. To control the operation of these components, some embodiments of power-system controls 26 may also include one or more other components. For example, as FIG. 2 shows, power-system controls 26 may include an information-processing device 152 operably connected to controller 112 of inverter 100 and to power regulator 102. Information-processing device 152 may also be operatively connected to prime mover 30, electric motor/generator 32, and electric motor 46 in a manner allowing information-processing device 152 to monitor and/or control one or more aspects of the operation of these components. Based on various operating parameters of prime mover 30, electric motor/generator 32, electric motor 46, and/or other components of power system 11, information-processing device 152 may perform high-level control of power system 11. Information-processing device 152 may include any suitable information processing device for controlling the components discussed above. In some embodiments, information-processing device 152 may include one or more microprocessors and/or one or more memory devices programmed to operate in the manners discussed below. Information-processing device 152 may be configured (i.e., programmed) in any suitable manner that allows it to perform the methods disclosed below.

Power-system controls 26 may also include components for monitoring various aspects of the operation of power system 11. For example, power-system controls 26 may include a voltage sensor 144 for sensing a voltage across terminals 54, 56 of electrical energy-storage device 48. Voltage sensor 144 may be directly or indirectly operably connected to information-processing device 152 to allow information-processing device 152 to monitor the voltage level of electrical energy-storage device 48. Power-system controls 26 may also include a current sensor 146 for sensing a magnitude of electric current exchanged between electrical energy-storage device 48 and power-transmission system 52. Like voltage sensor 144, current sensor 146 may be directly or indirectly operably connected to information-processing device 152 to allow information-processing device 152 to monitor the magnitude of electric current being exchanged between electrical energy-storage device 48 and power-transmission system 52.

Machine 10 and power system 11 are not limited to the configurations shown in FIGS. 1 and 2 and discussed above. For example, power-system controls 26 may include various other configurations and/or arrangements for monitoring and controlling the transmission of electricity between the various components of power system 11. Such other configurations of power-system controls 26 may include additional control components communicatively linked to one another and operable to share control tasks, such as other information-processing devices, in addition to information-processing device 152. Additionally, power-system controls 26 may include other numbers and/or configurations of power regulators, electrical connectors, and other components that transmit power between the power loads and power sources of power system 11. Power system 11 may also include other electrical energy-storage devices, in addition to electrical energy-storage device 48. Additionally, electric motor 46 may serve a function other than rotating superstructure 20 around axis 34, such as moving other components of machine 10 or supplying mechanical power to propel machine 10. Furthermore, machine 10 may be any of a number of types of machines other than an excavator, including a stationary machine. Moreover, whereas FIG. 2 shows power system 11 as a hybrid-electric type power system, power system 11 may be a pure-electric type power system without prime mover 30 and electric motor/generator 32.

### INDUSTRIAL APPLICABILITY

Machine 10 and power system 11 may have use in any application requiring power to perform one or more tasks. During operation of machine 10, information-processing device 152 may activate various electric loads to perform various tasks, such as activating electric motor 46 to rotate superstructure 20 around axis 34. Power system 11 may provide the electricity required to operate electric motor 46 and any other electric loads from various sources in various situations. Depending on the circumstances, power system 11 may provide electricity to electric motor 46 and the other electric loads from one or both of electric motor/generator 32 and electrical energy-storage device 48.

When the electrical needs of electric motor 46 and other electrical loads of power system 11 are high, information-processing device 152 may operate power-transmission system 52 to supply electricity from electrical energy-storage device 48 to one or more of the electrical loads of power system 11. At other times, information-processing device 152 may control power-transmission system 52 to supply electricity to electrical energy-storage device 48 to recharge it. Information-processing device 152 may use various strategies to control charging and discharging of electrical energy-storage device 48 based on various factors, including, but not limited to, an estimated state of charge of electrical energy-storage device 48, present power needs of machine 10, and anticipated power needs of machine 10.

As electrical energy-storage device 48 is charging and discharging, information-processing device 152 may monitor one or more operating parameters of electrical energy-storage device 48. For example, in some embodiments, information-processing device 48 may monitor a voltage level of electrical energy-storage device 48 by means of the signal received from voltage sensor 144. The voltage level of electrical energy-storage device 48 may increase during charging and decrease during discharging. Over a period of charging and discharging of electrical energy-storage device 48, information-processing device 152 may receive from voltage sensor 144 information indicative of a history of the voltage level of electrical energy storage device 48.

The sensed voltage level of electrical energy-storage device 48 may prove useful for inferring a variety of things about electrical energy-storage device 48. For example, the sensed voltage level at any given time may provide an indication of the state of charge of electrical energy-storage device 48, or the amount of energy presently stored in electrical energy-storage device 48. Additionally, the pattern of fluctuation of the sensed voltage level may provide an indication of how the state of charge of electrical energy-storage device 48 is changing over time. Furthermore, the pattern of fluctuation in the voltage level of electrical energy-storage device 48 may provide some indication of degradation in its ability to receive, store, and discharge electricity, or its state of health.

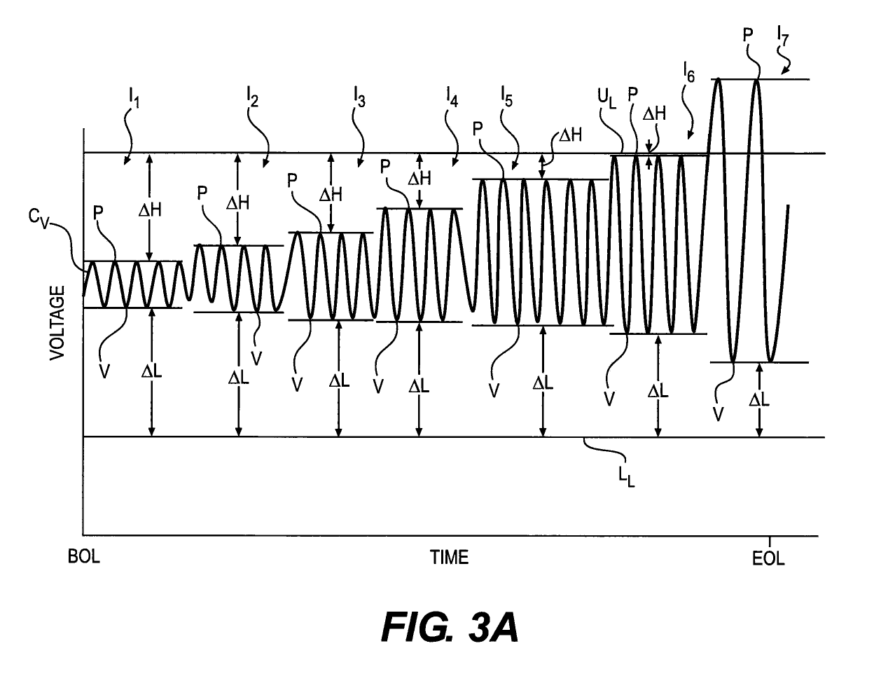

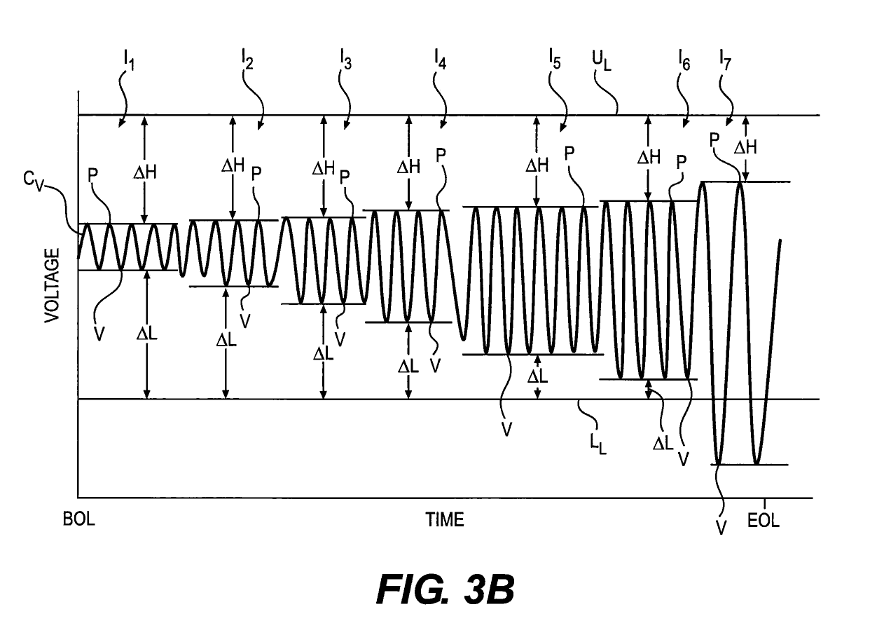

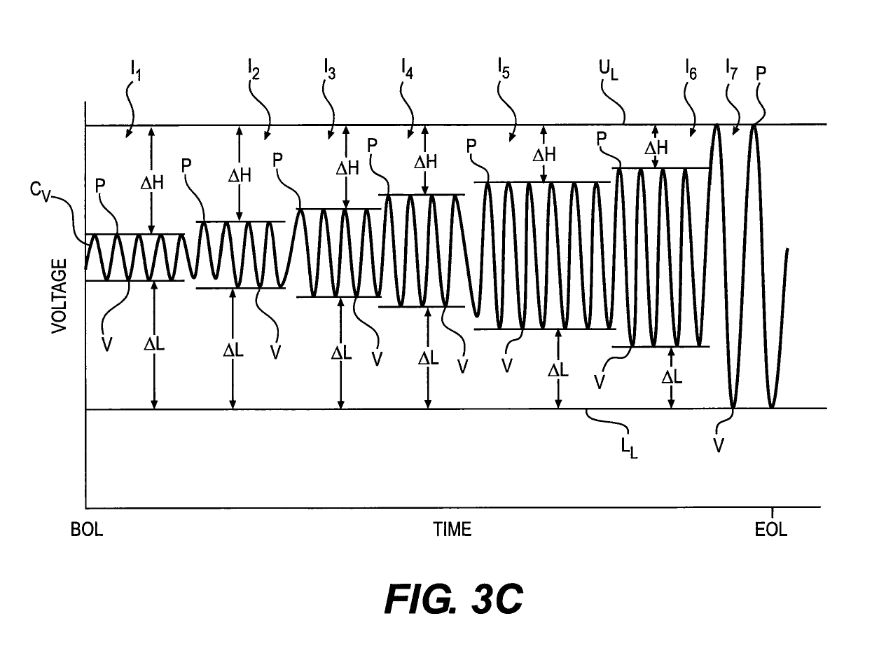

FIGS. 3A-C provide examples of how the pattern of fluctuation in the voltage level of electrical energy-storage device 48 might change over the course of its life. In each of these figures, time progresses along the horizontal axis and includes time intervals I₁-I₇. At the left side of the horizontal axis, BOL marks the beginning of life for electrical energy-storage device 48. Voltage curve C_{V} represents the fluctuations in the voltage level of electrical energy-storage device 48 over time. Lines U_{L} and L_{L} represent upper and lower limits for the voltage level of electrical energy-storage device 48. Limits U_{L} and L_{L} may have various values based on various considerations. In some embodiments, limits U_{L} and L_{L} may be determined based on the voltage limits of machine 10, voltage limits of components like power electronics components of machine 10, and/or the manufacturer's recommended highest and lowest acceptable voltage levels for electrical energy-storage 48.

Information-processing device 152 may monitor various aspects of the pattern of fluctuation in the voltage level of electrical energy-storage device 48. In some embodiments, information-processing device 152 may identify one or more peaks P and/or one or more valleys V in the sensed voltage level. For example, information-processing device 152 may ascertain that a peak P has occurred when the first derivative of the sensed voltage changes from positive to negative. Similarly, information-processing device 152 may ascertain that a valley V has occurred when the first derivative of the sensed voltage changes from negative to positive.

The identified peaks P and valleys V may provide valuable information about various aspects of the operation of power system 11. In general, the fluctuations in the voltage level and, thus, the magnitude of the peaks P and valleys V may provide an indication of how the state of charge of electrical energy-storage device 48 is changing over time. For example, filtered values of the peaks P and valleys V may provide a statistical average of the peaks P and valleys V at a given charge/discharge power during typical operating cycles within the operating state of charge range of electrical-energy-storage device 48. Furthermore, as discussed in greater detail below, the pattern of fluctuation in the voltage level and, thus, the identified peaks and valleys may provide an indication of the state of health of electrical energy-storage device 48.

Among various other things, information-processing device 152 may use the identified peaks P and valleys V to determine how close to the upper and lower limits U_{L} and L_{L} the voltage is fluctuating. To do so, information-processing device 152 may use the following equations:

ΔH=U_{L}−P

ΔL=V−L_{L}

ΔH is the difference between the upper limit U_{L} and a given peak P, and ΔL is the difference between a given valley V and the lower limit L_{L}. The values of ΔH and ΔL may provide a convenient indication of how close electrical energy-storage device 152 is operating to either of limits U_{L} and L_{L}. Additionally, the values of ΔH and ΔL may provide a convenient indication of the magnitude and pattern of fluctuations in the voltage level of electrical energy-storage device 48.

As FIGS. 3A and 3B, show one change that might occur in the pattern of fluctuation of the voltage level of electrical energy-storage device 48 over time is drifting of the fluctuations upward or downward. FIG. 3A shows a scenario where the voltage fluctuations drift up over time, and FIG. 3B shows a scenario where the voltage fluctuations drift down over time. Of course, in many circumstances, the voltage fluctuations may not drift steadily upward or steadily downward in the manner shown in FIGS. 3A and 3B, respectively, but may drift up and down sporadically over time. Upwardly drifting voltage fluctuations like those shown in FIG. 3A may indicate that the average state of charge of electrical energy-storage device 48 is increasing over time. Conversely, downwardly drifting voltage fluctuations like those shown in FIG. 3B may indicate that the average state of charge of electrical energy-storage device 48 is decreasing over time.

Another change that might occur in the pattern of fluctuation of the voltage level of electrical energy-storage device 48 over time is an increase in the magnitude of fluctuation. This may occur due at least in part to increasing internal resistance of electrical energy-storage device 48 over time. For a given amount of charging, a higher internal resistance may cause a greater voltage differential from terminals 54, 56 to the interior of electrical energy-storage device 48, which may cause a higher sensed voltage at terminals 54, 56. Similarly, for a given amount of discharging, higher internal resistance may cause a greater voltage differential from the interior of electrical energy-storage device 48 to terminals 54, 56, which may cause a lower sensed voltage at terminals 54, 56. Thus, increases in the magnitude of fluctuations between the peaks P and valleys V of the voltage level may indicate increasing internal resistance and decreasing state of health of electrical energy-storage device 48.

In the disclosed embodiments, information-processing device 152 may capitalize on the foregoing phenomenon associated with the sensed voltage level and the pattern of voltage fluctuation to achieve various objectives. Information-processing device 152 may use information about the monitored voltage level to monitor the state of charge of electrical energy-storage device 48. For example, in the circumstances shown in FIG. 3A, information-processing device 152 may identify from the upwardly drifting voltage fluctuations that the average state of charge of electrical energy-storage device 48 is drifting upward over time. Conversely, in the circumstances shown in FIG. 3B, information-processing device 152 may identify from the downwardly drifting voltage fluctuations that the average state of charge of electrical energy-storage device 48 is drifting downward over time.

Additionally, information-processing device 152 may control charging and discharging of electrical energy-storage device 48 based on the monitored voltage level to maintain the state of charge of electrical energy-storage device 48 in a desired range. Information-processing device 152 may do so in a variety of ways. In some embodiments, information-processing device 152 may control charging and discharging of electrical energy-storage device 48 to maintain target values of ΔH and ΔL or target relationships between these two values.

For example, information-processing device 152 may modify the strategy for charging and discharging electrical energy-storage device 48 in response to a change in the pattern of fluctuation in the sensed voltage. If information-processing device 152 detects a pattern of increasing or decreasing voltage levels, it may modify the strategy used to control charging and discharging of electrical energy-storage device 48. For example, if information-processing device 152 detects a pattern of decreasing voltage levels like that shown in FIG. 3B, it may respond by increasing charging and/or decreasing discharging of electrical energy-storage device 48. Conversely, if information-processing device 152 detects a pattern of increasing voltage levels like that shown in FIG. 3A, it may respond by decreasing charging and/or increasing discharging of electrical energy-storage device 48.

Information-processing device 152 may use various approaches when modifying the charging and discharging strategy in response to changes in the pattern of fluctuation in the voltage level. In some embodiments, information-processing device 152 may modifying charging and discharging as necessary to maintain the voltage fluctuations substantially centered between upper and lower limits U_{L} and L_{L}. Information-processing device 152 may do so, for example, by controlling charging and discharging in a manner to maintain ΔH and ΔL substantially equal to one another. Such a strategy may result in a pattern of voltage fluctuations like that shown in FIG. 3C. Alternatively, information-processing device 152 may modify the charging and discharging strategy in various other ways to provide a desired state of charge level. For example, information-processing device 152 may control charging and discharging to maintain a somewhat constant ratio between ΔH and ΔL, or only as necessary to maintain the voltage fluctuations between upper and lower limits U_{L} and L_{L}.

Information-processing device 152 may also rely at least in part on the pattern of fluctuation in the voltage level of electrical energy-storage device 48 to monitor a state of health of electrical energy-storage device 48. This may include using the sensed voltage level to determine when electrical energy-storage device 48 is approaching and/or has reached the end of its useful life. Information-processing device 152 may do so in various ways. Information-processing device 152 may determine whether electrical energy-storage device 48 is approaching and/or has reached the end of its useful life based exclusively on the sensed voltage level, or based on the sensed voltage level in combination with other factors.

In some embodiments, information-processing device 152 may determine whether electrical energy-storage device 48 is approaching and/or has reached the end of its useful life by monitoring whether the voltage level fluctuates close to or beyond the upper and/or lower voltage limits U_{L} and L_{L}. For example, information-processing device 152 may determine whether electrical energy-storage device 48 is approaching or has reached the end of its useful life by monitoring the values of ΔH and ΔL over the course of time.

As the values of ΔH and ΔL decrease, information-processing device 152 may ascertain that electrical energy-storage device 48 is progressing toward the end of its useful life. This may involve information-processing device 152 making various determinations. In some embodiments, information-processing device 152 may generate a quantitative representation of a state of health of electrical energy-storage device 48. For example, based on the values of ΔH and ΔL, information-processing device 152 may calculate an estimated percentage of remaining service life for electrical energy-storage device 48. Additionally or alternatively, information-processing device 152 may generate one or more qualitative representations of the state of health of electrical energy-storage device 48. For example, at some point, information-processing device 152 may make a discrete determination that electrical energy-storage device 48 has reached a state near the end of its useful life.

As the values of ΔH and ΔL continue to decrease, information-processing device 152 may eventually deem electrical energy-storage device 48 at the end of its useful life. In embodiments where information-processing device 152 generates a quantitative representation of the state of health, it may deem the electrical energy-storage device 152 at the end of its useful life when the quantitative representation reaches a certain level. For example, where the information-processing device 152 estimates a percentage of remaining service life, it may deem electrical energy-storage device 48 at the end of its useful life when the estimated remaining service life reaches zero. Alternatively, information-processing device 152 may simply deem electrical energy-storage device 48 at the end of its useful life when ΔH and/or ΔL meet certain criteria, such as falling to zero for one or more times.

In addition to or instead of the magnitude of fluctuations in the sensed voltage level (as represented by the values of ΔH and ΔL), information-processing device 152 may use various other aspects of the pattern of fluctuation in the voltage level to assess the state of health of electrical energy-storage device 48. For example, information-processing device 152 may monitor the rate of voltage drop during discharging events as an indicator of the state of health of electrical energy-storage device 48. For a given power draw, a faster voltage drop may indicate a lesser state of health of electrical energy-storage device 48. Information-processing device 152 may generate an estimate of the state of health of electrical energy-storage device 48 based in part on a rate of voltage drop during one discharging event by itself. Alternatively, information-processing device 152 may generate an estimate of a state of health of electrical energy-storage device 48 based on a relationship between the rate of voltage drop during different discharging events at different points in time.

Information-processing device 152 may use the foregoing information in various ways. In some embodiments, information-processing device 152 may communicate the estimated state of health of electrical energy-storage device 48 to various other entities. For example, information-processing device 152 may communicate an estimated state of health of electrical energy-storage device 48 to an operator of machine 10, service personnel, and/or other individuals via means such as operator and/or service interfaces.

Methods of monitoring electrical energy-storage device 48 and controlling charging and discharging thereof are not limited to the examples discussed above. For instance, information-processing device 152 may use approaches other than monitoring ΔH and ΔL to identify increases in the magnitude of voltage fluctuations. Additionally, information-processing device 152 may use aspects of the pattern of voltage fluctuation other than the magnitude of fluctuation and the rate of voltage drop to evaluate the state of health of electrical energy-storage device 48. Similarly, information-processing device 152 may use alternative criteria for deeming that electrical energy-storage device 48 is reaching or at the end of its useful life. Furthermore, information-processing device 152 may use different strategies for controlling charging and discharging based on the pattern of voltage fluctuations. Some such strategies may result in more tumultuous patterns of fluctuation than that shown in FIG. 3.

The disclosed embodiments may provide certain advantages. For example, controlling charging and discharging based on monitored fluctuations in the voltage level may provide a simple means of controlling or maintaining the operating cycle within a desired state of charge range without requiring knowledge of the exact state of charge. Additionally, the disclosed methods of monitoring fluctuations in the voltage level of electrical energy-storage device 48 may provide simple, effective ways to monitor changes in the state of health of electrical energy-storage device 48 and to adjust charging and discharging to account for such changes. This may enhance the ability to use electrical energy-storage device 48 effectively and efficiently over its entire life. By helping keep electrical energy-storage device 48 within its upper and lower voltage limits U_{L} and L_{L}, the disclosed methods may allow longer use of electrical energy-storage device 48. Additionally, the disclosed methods may also allow accurately anticipating when it may become infeasible to operate electrical energy-storage device 48 within these limits, so that electrical energy-storage device 48 can be replaced in a timely fashion.

It will be apparent to those skilled in the art that various modifications and variations can be made in the disclosed system and methods without departing from the scope of the disclosure. Other embodiments of the disclosed system and methods will be apparent to those skilled in the art from consideration of the specification and practice of the system and methods disclosed herein. It is intended that the specification and examples be considered as exemplary only, with a true scope of the disclosure being indicated by the following claims and their equivalents.

What is claimed is:

1. A method of estimating a state of health of an electrical energy-storage device, the method comprising:
receiving information indicative of a history of a voltage level of the electrical energy-storage device during a history of charging and discharging of the electrical energy-storage device;
using the received information to estimate at least one peak or valley in the history of the voltage level; and
using at least one information-processing device to generate an estimate of a state of health of the electrical energy-storage device based on the at least one estimated peak or valley.

2. The method of claim 1, wherein using the at least one information-processing device to generate an estimate of a state of health of the electrical energy-storage device based on the at least one estimated peak or valley includes generating an indication of whether the electrical energy-storage device has reached an end of its useful life.

3. The method of claim 2, wherein generating an indication of whether the electrical energy-storage device has reached an end of its useful life includes comparing the at least one peak or valley to a reference voltage value.

4. The method of claim 3, wherein comparing the at least one peak or valley to a reference voltage value includes comparing the at least one peak or valley to a predetermined upper or lower voltage limit for the electrical energy-storage device.

5. The method of claim 1, wherein using the at least one information-processing device to generate an estimate of a state of health of the electrical energy-storage device based on the at least one estimated peak or valley includes comparing the at least one peak or valley to a reference voltage value.

6. The method of claim 5, wherein comparing the at least one peak or valley to a reference voltage value includes comparing the at least one peak or valley to a predetermined upper or lower voltage limit for the electrical energy-storage device.

7. The method of claim 1, wherein using the at least one information-processing device to generate an estimate of a state of health of the electrical energy-storage device based on the at least one estimated peak or valley includes generating a quantitative representation of the state of health of the electrical energy-storage device.

8. A method of operating a power system with an electrical energy-storage device, the method comprising:
charging and discharging the electrical energy-storage device according to a charging and discharging strategy;
receiving information indicative of a history of a voltage level of the electrical energy-storage device during a history of the charging and discharging of the electrical energy-storage device; and
modifying the charging and discharging strategy in response to a change in a pattern of fluctuation of the voltage level during the history of charging and discharging.

9. The method of claim 8, wherein modifying the charging and discharging strategy in response to a change in a pattern of fluctuation of the voltage level during the history of charging and discharging includes responding to a pattern of decreasing voltage levels by at least one of increasing charging or decreasing discharging.

10. The method of claim 9, wherein modifying the charging and discharging strategy in response to a change in a pattern of fluctuation of the voltage level during the history of charging and discharging includes responding to a pattern of increasing voltage levels by at least one of decreasing charging or increasing discharging.

11. The method of claim 10, wherein responding to a pattern of increasing voltage levels by at least one of decreasing charging or increasing discharging includes modifying at least one of the charging and discharging in a manner to substantially center voltage fluctuations between an upper voltage limit and a lower voltage limit for the electrical energy-storage device.

12. The method of claim 9, wherein responding to a pattern of decreasing voltage levels by at least one of increasing charging or decreasing discharging includes modifying at least one of the charging and discharging in a manner to substantially center voltage fluctuations between an upper voltage limit and a lower voltage limit for the electrical energy-storage device.

13. The method of claim 8, wherein modifying the charging and discharging strategy in response to a change in a pattern of fluctuation of the voltage level during the history of charging and discharging includes modifying at least one of the charging and discharging in a manner to substantially center voltage fluctuations between an upper voltage limit and a lower voltage limit for the electrical energy-storage device.

14. The method of claim 8, wherein modifying the charging and discharging strategy in response to a change in a pattern of fluctuation of the voltage level during the history of charging and discharging includes responding to a pattern of increasing voltage levels by at least one of decreasing charging or increasing discharging.

15. The method of claim 8, further comprising using the at least one information-processing device to generate an estimate of a state of health of the electrical energy-storage device based on at least one aspect of the pattern of fluctuation in the voltage level of the electrical energy-storage device during the history of charging and discharging.

16. A power system, comprising:
an electrical energy-storage device; and
at least one information-processing device configured to
receive information indicative of a history of a voltage level of the electrical energy-storage device during a history of charging and discharging of the electrical energy-storage device,
identify peaks and valleys in the history of the voltage level of the electrical energy-storage device, and
perform at least one of monitoring a state of charge of the electrical energy-storage device based at least in part on the identified peaks and valleys or controlling the state of charge of the electrical energy-storage device based at least in part on the identified peaks and valleys.

17. The power system of claim 16, wherein the at least one information-processing device is configured to control the state of charge of the electrical energy-storage device based at least in part on the identified peaks and valleys.

18. The power system of claim 17, wherein controlling the state of charge of the electrical energy-storage device based at least in part on the identified peaks and valleys includes controlling charging and discharging of the electrical energy-storage device to achieve at least one desired relationship between at least one reference voltage level and the identified peaks and valleys.

19. The power system of claim 16, wherein the at least one information-processing device is configured to monitor the state of charge of the electrical energy-storage device based at least in part on the identified peaks and valleys.

20. The power system of claim 19, wherein monitoring the state of charge of the electrical energy-storage device based at least in part on the identified peaks and valleys includes monitoring a relationship between at least one reference voltage level and the identified peaks and valleys.
